(19) United States
(12) Patent Application Publication
(10) Pub. No.: US 2022/0391084 A1
(43) Pub. Date: Dec. 8, 2022

(54) INFORMATION DISPLAY METHOD, READER, COMPUTER STORAGE MEDIUM, INK SCREEN READING DEVICE AND SCREEN PROJECTION DISPLAY SYSTEM

(71) Applicants: ZHANGYUE TECHNOLOGY CO., LTD, Beijing (CN); SHENZHEN ZHANGYUE TECHNOLOGY CO., LTD, Shenzhen (CN)

(72) Inventors: Chao CHENG, Beijing (CN); Bin LIU, Beijing (CN); Hongtao TAO, Beijing (CN)

(21) Appl. No.: 17/762,367

(22) PCT Filed: Nov. 20, 2019
(86) PCT No.: PCT/CN2019/119780

§ 371 Date: Mar. 22, 2022

(30) Foreign Application Priority Data
Sep. 25, 2019 (CN) 201910913498.3
Sep. 25, 2019 (CN) 201921614685.3

(51) Int. Cl. G06F 3/04883; G06F 9/451; G06F 3/046

(52) U.S. Cl. CPC G06F 3/04883; G06F 9/451; G06F 3/046

(57) ABSTRACT

The present invention discloses a method of displaying information, a reader, a computer storage medium, an ink screen reading device and a screen projection displaying system, wherein the information displaying method includes: detecting handwriting report point data generated based on handwriting operations; modifying an interface image stored in a display cache based on the handwriting report point data, and synchronizing the modified interface image to an ink screen for display; and updating handwriting content drawn on a handwriting layer in a system cache based on the handwriting report point data, obtaining a screen projection image by performing layer synthesis processing on the updated handwriting layer and a plurality of interface layers to be displayed after completing each updating, and sending the screen projection image to a screen projection device for displaying the screen projection image.

### CROSS-REFERENCE TO RELATED APPLICATIONS

The present application claims the priorities of the Chinese patent applications with the application number of 201910913498.3 and the title of “Method of Displaying Information, Reader and Computer Storage Medium” filed with the China Patent Office on Sep. 25, 2019 and with the application number of 201921614685.3 and the title of “Ink Screen Reading Device and Screen projection Display System” filed with the China Patent Office on Sep. 25, 2019, the entire contents of which are incorporated herein by reference.

### TECHNICAL FIELD

The present disclosure relates to the field of computer technology, and in particular to a method of displaying information, a reader, a computer storage medium, an ink screen reading device and a screen projection display system using the method to display information.

### BACKGROUND

An ink screen reading device refers to an electronic reading device that uses an electronic ink screen (Electronic-ink or Electronic Paper Display/EPD). The electronic ink screen is a screen that does not emit light by itself but relies on external reflection to achieve display effect, and its display effect is very similar to that of paper materials, so experience of reading the electronic ink screen and reading paper materials are comparable. The electronic ink screen is composed of many microcapsules, and each microcapsule includes a plurality of black particles and a plurality of white particles, both of which have opposite charges respectively. When black contents need to be displayed on the screen, the black particles are driven through a voltage to move up to the top of the screen (that is, move from the bottom to the direction of the screen), and when white contents will be displayed, the white particles are driven through a voltage to move up to the top of the screen (that is, move from the bottom to the direction of the screen).

At the same time, some ink screen reading devices further have an electromagnetic film, through which an electromagnetic handwriting function is provided, and a user can use a handwriting stylus to write any handwriting content on these reading devices. Induction data of the handwriting will be received by the electromagnetic film, and the handwriting content can finally be displayed in the reader by processing of the induction data, thereby facilitating the user to mark in the process of reading. And in the process of actually using the above-mentioned ink screen reading device that provides the electromagnetic handwriting function, especially in the process of conference, learning exchange, etc., there is often a need to transmit the content displayed in the reader to other devices, which also includes transmitting the handwriting content to other devices, for example, screen-projecting the handwriting content to other devices.

However, in the existing handwriting sharing solution, it is usually only possible to transmit the completely handwriting content to other devices for viewing in other devices after the writing of the handwriting is completed. The real-time performance of the sharing solution is poor, for example, the existing ink screen reading device cannot take into account display in both the ink screen and the screen projection device.

### SUMMARY

In view of the above problems, the present disclosure is proposed to provide a method of displaying information, a reader, a computer storage medium, an ink screen reading device and a screen projection display system that overcome or at least partially solve the above problems.

According to one aspect of the present disclosure, a method of displaying information is provided, which includes:

detecting handwriting report point data generated based on handwriting operations;

modifying an interface image stored in a display cache based on the handwriting report point data, and synchronizing the modified interface image to an ink screen for display; and

updating handwriting content drawn on a handwriting layer in a system cache based on the handwriting report point data, obtaining a screen projection image by performing layer synthesis processing on the updated handwriting layer and a plurality of interface layers to be displayed after completing each updating, and sending the screen projection image to a screen projection device for displaying the screen projection image.

According to another aspect of the present disclosure, a reader is provided, which includes: a processor, a memory, a communication interface and a communication bus, wherein the processor, the memory and the communication interface communicate with each other through the communication bus, wherein the memory is configured to store executable instructions that upon execution cause the processor to perform operations, the operations comprising:

detecting handwriting report point data generated based on handwriting operations;

modifying an interface image stored in a display cache based on the handwriting report point data, and synchronizing the modified interface image to an ink screen for display; and

updating handwriting content drawn on a handwriting layer in a system cache based on the handwriting report point data, obtaining a screen projection image by performing layer synthesis processing on the updated handwriting layer and a plurality of interface layers to be displayed after completing each updating, and sending the screen projection image to a screen projection device for displaying the screen projection image.

According to further another aspect of the present disclosure, a non-volatile computer-readable storage medium is provided, in which at least one executable instruction is stored, which causes a processor to perform the following operations of:

detecting handwriting report point data generated based on handwriting operations;

modifying an interface image stored in a display cache based on the handwriting report point data, and synchronizing the modified interface image to an ink screen for display; and

updating handwriting content drawn on a handwriting layer in a system cache based on the handwriting report point data, obtaining a screen projection image by performing layer synthesis processing on the updated handwriting layer and a plurality of interface layers to be displayed after completing each updating, and sending the screen projection image to a screen projection device for displaying the screen projection image.

According to yet another aspect of the present disclosure, a computer program product is provided, which includes a computer program stored on the above non-volatile computer-readable storage medium.

According to the method of displaying information, the reader and the computer storage medium of the present disclosure, when the handwriting report point data generated by the handwriting operations is detected, on the one hand, the interface image in the display cache is modified based on the handwriting report point data by way of image modification, and a modified interface image including the handwriting content can be obtained through modification to be refreshed and displayed in the ink screen, so that response speed of handwriting can be accelerated, thereby realizing smooth display of the handwriting content; on the other hand, the handwriting content drawn on the handwriting layer is updated based on the handwriting report point data by way of layer synthesis processing, and the screen projection image is obtained by performing layer synthesis processing on the updated handwriting layer and a plurality of interface layers after completing updating, so as to display the screen projection image in the screen projection device. As can be seen that, in the present embodiment, the screen projection image can be obtained to be projected in real time, through synthesis based on the new real-time report point data by continuously detecting the handwriting report point data, so that real-time screen projection of the handwriting content is realized and real-time performance of screen projection is improved; and the interface image and the screen projection image are obtained by way of modifying the image and synthesizing the layer, respectively, thus real-time screen projection of the handwriting content is realized while response speed of handwriting is ensured.

According to yet another aspect of the present disclosure, an ink screen reading device for performing information displaying by using a method of displaying information disclosed by the present application is provided, which includes a System on Chip, a display controller, an ink screen, an electromagnetic film and a communication interface; the System on Chip is provided with a data input port and a data output port, and the System on Chip is electrically connected with the electromagnetic film through the data input port to receive induction data transmitted by the electromagnetic film; the System on Chip is electrically connected with the display controller through the data output port to send a refreshed image to the display controller; the display controller is electrically connected with the ink screen to transmit driving signals of the refreshed image to the ink screen so as to drive the ink screen to display the refreshed image; the System on Chip is electrically connected with the communication interface to transmit a screen projection image to a screen projection device through the communication interface.

According to another aspect of the present disclosure, a screen projection displaying system is provided, which includes an ink screen reading device disclosed by the present application, and at least one screen projection device; wherein each screen projection device is connected with the ink screen reading device through a local area network to receive and display the screen projection image sent by the ink screen reading device.

According to yet another aspect of the present disclosure, a screen projection displaying system is provided, which includes at least two of any ink screen reading devices disclosed by the present application, and at least one ink screen reading device of the at least two ink screen reading devices is used as a screen projection device for any other ink screen reading device.

According to the ink screen reading device and the screen projection displaying system of the present disclosure, the System on Chip therein is electrically connected with the electromagnetic film through the data input port. On this basis, firstly, the System on Chip is electrically connected with the display controller through the data output port, and the display controller is electrically connected with the ink screen, and displaying of the handwriting content on the ink screen can be realized through the sequential electrical connection among the System on Chip, the display controller and the ink screen; secondly, the System on Chip is electrically connected with the communication interface, and transmission of the screen projection image to the screen projection device for screen projection displaying can be realized at the same time. As can be seen that, in the ink screen reading device provided by the present disclosure, by establishing electrical connection of the System on Chip with the screen projection device and the display controller, respectively, synchronized displaying of the handwriting content on the ink screen and the screen projection device can be realized in the process of inputting handwriting by a user.

The above explanation is only an overview of the technical solutions of the present disclosure. In order to enable a clearer understanding of the technical means of the present disclosure so as to be able to be implemented in accordance with the contents of the description, and in order to enable the above and other purposes, features and advantages of the present disclosure more obvious and easier to understand, the specific embodiments of the present disclosure will be specifically given below.

### BRIEF DESCRIPTION OF THE DRAWINGS

Various other advantages and benefits will become apparent to those ordinarily skilled in the art upon reading the following detailed description of the preferred embodiments. The drawings are for purposes of illustrating preferred embodiments only and are not to be considered as limiting of the present disclosure. Also, the same components are denoted by the same reference numerals throughout the drawings. In the drawings:

FIG. 1 shows a flowchart of an embodiment of a method of displaying information of the present disclosure;

FIG. 2 shows a flowchart of another embodiment of the method of displaying information of the present disclosure;

FIG. 3 shows a schematic diagram of a plurality of interface layers in one specific page;

FIG. 4 shows a schematic structural diagram of an embodiment of a reader of the present disclosure;

FIG. 5 shows a schematic structural diagram of an ink screen reading device provided by an embodiment of the present disclosure;

FIG. 6 shows a schematic structural diagram of an ink screen reading device provided by another embodiment of the present disclosure;

FIG. 7 shows a composition block diagram of a screen projection displaying system provided in an embodiment of the present disclosure;

FIG. 8 shows a composition block diagram of a screen projection displaying system provided by another embodiment of the present disclosure;

FIG. 9 shows a composition block diagram of a screen projection displaying system composed of two ink screen readers.

### DETAILED DESCRIPTION

Exemplary embodiments of the present disclosure will be described in more detail below with reference to the accompanying drawings. While exemplary embodiments of the present disclosure are shown in the drawings, it should be understood that the present disclosure can be embodied in various forms and should not be limited by the embodiments set forth herein. Rather, these embodiments are provided so that the present disclosure can be more thoroughly understood, and the scope of the present disclosure can be fully conveyed to those skilled in the art.

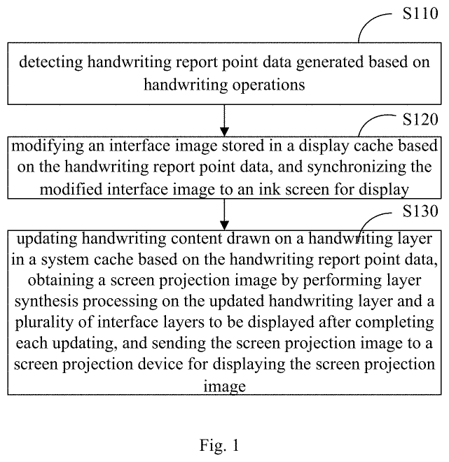

FIG. 1 shows a flowchart of an embodiment of a method of displaying information of the present disclosure. The method is applied into an ink screen reader which supports handwriting operations. As shown in FIG. 1, the method includes the following steps:

a step S110: detecting handwriting report point data generated based on handwriting operations.

In the present disclosure, the ink screen reader provides a handwriting function, and a user can use a handwriting stylus to perform the handwriting operations on the reader, thereby generating handwriting content.

Specifically, in the process of the user performing the handwriting operations, the electromagnetic film will detect a real-time handwriting report point data generated based on the handwriting operations. The handwriting report point data at least includes data of at least one of reflecting pressure sensing, the position of the handwriting point, and the dwell time of the handwriting point, so as to subsequently determine the handwriting content written by the handwriting operations.

It should be noted here that the process of detecting the handwriting report point data is in real time. With the user's handwriting operations, new real-time report point data will be generated in real time, and then the electromagnetic film will detect the new handwriting report point data generated in real time.

a step S120: modifying an interface image stored in a display cache based on the handwriting report point data, and synchronizing the modified interface image to an ink screen for display.

The display cache is configured to store images being displayed in the ink screen, including the interface image or the modified interface image; and, the interface image refers to the image currently displayed in the ink screen, and the modified interface image refers to the image to be displayed in the ink screen.

Specifically, the image displayed in the ink screen may only include the interface content, and not include the handwriting content generated based on the handwriting operations, wherein the interface contents refer to the contents of the page that needs to be displayed and is composed of a plurality of interface layers, which usually corresponds to the situation where the handwriting operations is not performed at this time; or, the image beinig displayed in the ink screen may include the interface contents and the handwriting content generated by the handwriting operations, which usually corresponds to the situation where the handwriting operations has already been performed and the interface image has been modified at this time.

Moreover, in the present disclosure, refresh of the image displayed in the ink screen will be realized by modifying the interface image stored in the display cache. After continuously receiving the new handwriting report point data transmitted by the electromagnetic film, the interface image will be modified based on the handwriting report point data, that is, the interface image will be modified directly as a whole. For example, new handwriting content will be added onto the interface image, and based on the modified interface image, the ink particles in the ink screen will be driven to move, so as to display the modified interface image.

Through this step S120, by modifying the interface image stored in the display cache, synchronous display of the handwriting content generated by the handwriting operations in the ink screen can be realized. This manner is used for the handwriting operations changed continuously, and since there is no layers merge process involved, the interface image to be displayed can be obtained quickly, so that refresh and display of the ink screen can be performed efficiently and response speed of the handwriting can be improved.

a step S130: updating handwriting content drawn on a handwriting layer in a system cache based on the handwriting report point data, obtaining a screen projection image by performing layer synthesis processing on the updated handwriting layer and a plurality of interface layers to be displayed after completing each updating, and sending the screen projection image to a screen projection device for displaying the screen projection image.

The system cache is configured to store the handwriting layer required for obtaining the screen projection image through synthesis, and the handwriting layer is dedicated to drawing the handwriting content.

The screen projection device may be any electronic device that can establish a communication connection with the ink screen reader performing the solution of the present disclosure and has a display function. For example, the screen projection device is another reader, a mobile phone, a tablet, a personal computer or a projector and the like. Optionally, a communication connection is established between the ink screen reader and the screen projection device through a local area network, for example, a wifi connection.

Specifically, the screen projection image displayed in the screen projection device is obtained by way of layer synthesis processing. In the process of obtaining the screen projection image, first the handwriting content drawn on the handwriting layer is updated, that is, the handwriting content written by handwriting operations will be drawn into the handwriting layer, so that the handwriting content in the handwriting layer is kept consistent with the content written by the user; after update of the handwriting content drawn on the handwriting layer is completed once, the layer synthesis process is performed to obtain a screen projection image that is the same as the interface contents and the handwriting content written and completed in real time; and then the screen projection image is sent to the screen projection device, so that the display of the same image in the screen projection device as in the ink screen can be realized.

Through the above step S130, by way of performing layer synthesis processing on the handwriting layer and the interface layer, the screen projection image for screen projection display in the screen projection device can be obtained, and the handwriting content generated by the user in real time can be projected into the screen projection device, and the real-time projection screen of the handwriting content can be realized.

It should be noted here that, in the present disclosure, the above steps S120 and S130 may not be executed in order, and optionally, the two steps may be executed at the same time, so as to realize efficient display in the ink screen and the screen projection device at the same time; or, the execution of the steps S130 and S120 may also be started successively and respectively, so as to realize synchronous display in the ink screen and the screen projection device, and avoid display lag in the screen projection device.

According to the method of displaying information provided by the present embodiment, when the handwriting report point data generated by the handwriting operations is detected, on the one hand, the interface image in the display cache is modified based on the handwriting report point data by way of image modification, and a modified interface image including the handwriting content can be obtained through modification to be refreshed and displayed in the ink screen, so that response speed of handwriting can be accelerated, thereby realizing smooth display of the handwriting content; on the other hand, the handwriting content drawn on the handwriting layer is updated based on the handwriting report point data by way of layer synthesis processing, and the screen projection image is obtained by performing layer synthesis processing on the updated handwriting layer and a plurality of interface layers after completing updating, so as to display the screen projection image in the screen projection device. As can be seen that, in the present embodiment, the screen projection image can be obtained to be projected in real time, through synthesis based on the new real-time report point data by continuously detecting the handwriting report point data, so that real-time screen projection of the handwriting content is realized and real-time performance of screen projection is improved; and the interface image and the screen projection image are obtained by way of modifying the image and synthesizing the layer, respectively, thus real-time screen projection of the handwriting content is realized while response speed of handwriting is ensured.

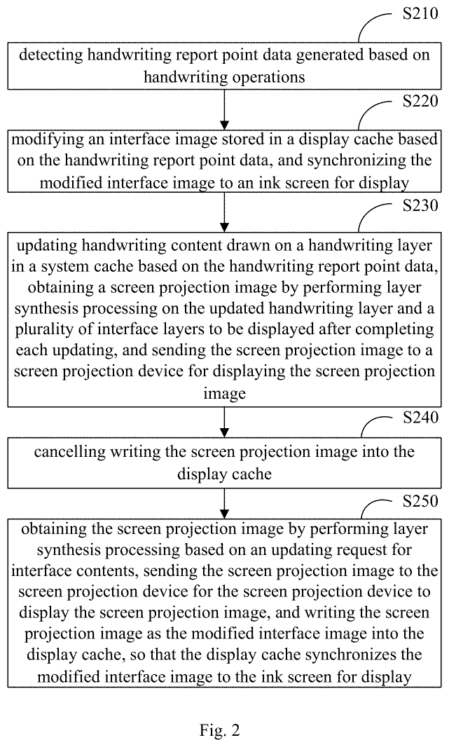

FIG. 2 shows a flowchart of another embodiment of a method of displaying information of the present disclosure. The method is applied into an ink screen reader which supports handwriting operations. As shown in FIG. 2, the method includes the following steps:

a step S210: detecting handwriting report point data generated based on handwriting operations.

The handwriting report point data at least includes data of at least one of reflecting pressure sensing, the position of the handwriting point, and the dwell time of the handwriting point, so as to subsequently determine the handwriting content written by the handwriting operations. In some specific embodiments, the data reflecting the position of the handwriting point may be handwriting point coordinates, and the data reflecting the dwell time of the handwriting point may be handwriting point moving speed.

a step S220: modifying an interface image stored in a display cache based on the handwriting report point data, and synchronizing the modified interface image to an ink screen for display.

Specifically, the modified interface image can be obtained by way of image modification. The interface image stored in the display cache will be acquired, and this interface image refers to the image currently displayed in the ink screen. It should be noted here that this image currently displayed may be a screen projection image obtained through layer synthesis processing (that is, obtained by writing the screen projection image into the cache, please refer to the description of step S250 below for detail), and may also be the modified interface image obtained after previous modification. Based on the handwriting report point data, the handwriting content is added on the interface image, and the interface image with the handwriting content added is written into the display cache as the modified interface image. After new handwriting report point data is received every time, the handwriting report point data will be converted into the handwriting content, and the handwriting content will be add to the position on the interface image corresponding to the coordinates of the handwriting point to obtain the modified interface image. Optionally, modifying the interface image in the display cache may be performed by a System on Chip (System on Chip, SOC for short) in the reader. In the ink screen reader, the interface image and the modified interface image are both grayscale images, so as to look up a look-up-table (LUT) based on the grayscale images and drive the ink particles to image subsequently. The driving waveform is obtained by looking up the LUT based on the modified interface image; and the ink particles is driven to move based on the driving waveform, so that the modified interface image can be displayed in the ink screen.

For example, what is currently displayed in the ink screen is the interface image p1, and the interface image p1 only includes the contents of page 1 without any handwriting content. And correspondingly, what is stored in the display cache is the interface image p1 that does not include any handwriting content. When the handwriting report point data is detected, the handwriting report point data will be converted into the handwriting content. Assuming the handwriting content is a horizontal line, then the horizontal line (i.e. “—”) will be added to the corresponding position in the interface image p1 to obtain an interface image p2 including the handwriting content “—”. At this time, the interface image p2 then can be displayed on the ink screen; on this basis, if the handwriting report point data is continuously detected, then the new handwriting report point data will be continuously converted into the handwriting content. Assuming the handwriting content is a vertical line, then the vertical line (i.e. “|”) will be added to the corresponding position in the interface image p2 including the handwriting content “—”, and an interface image p3 including the handwriting content “ [symbol] ” will be obtained, and then the interface image p3 can be displayed in the ink screen at this time.

a step S230: updating handwriting content drawn on a handwriting layer in a system cache based on the handwriting report point data, obtaining a screen projection image by performing layer synthesis processing on the updated handwriting layer and a plurality of interface layers to be displayed after completing each updating, and sending the screen projection image to a screen projection device for displaying the screen projection image.

The handwriting layer is a transparent layer, and the size of the handwriting layer is the same as the size of the interface of the ink screen.

Specifically, the screen projection image will be obtained by way of layer synthesis. In the process of obtaining the screen projection image, the handwriting layer is updated first, and and handwriting content drawn on the handwriting layer is updated in the system cache based on the handwriting report point data and preset handwriting parameters. The handwriting report point data refers to operation parameters reflected by a handwriting operations, such as the coordinates of the handwriting point and the like, and the preset handwriting parameters refer to personalized attribute settings of the handwriting operations, which cannot be reflected from the handwriting operations. Optionally, the preset handwriting parameters include at least one of line color, line width and stroke effect, but not limited to this. In this way, the handwriting content, which are the same as the trajectory of the handwriting operations and consistent with the preset handwriting parameters, can be drawn in the handwriting layer. Optionally, the updating the handwriting layer may also be performed by a System on Chip.

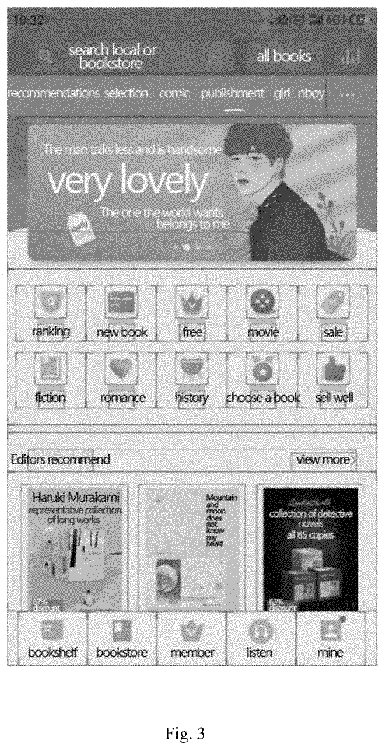

Then, the updated handwriting layer will be superimposed onto the plurality of interface layers to obtain the screen projection image, wherein the handwriting layer is a transparent layer, which cannot block the display of the contents in the plurality of interface layers after being superimposed onto the plurality of interface layers. In the present embodiment, a page is composed of a plurality of interface layers, each of which is used to display a part of the elements in the page, and which may be superimposed in the vertical direction of the page, or may also exist in the same level of the 2D plane of the page in the form of non-superimposition. FIG. 3 shows a schematic diagram of a plurality of interface layers in one specific page. As shown in FIG. 3, bookshelf, bookstore, member, etc. on the bottom are displayed through one interface layer, and entrances for ranking, new book, free, movie, etc. in the middle are displayed through another interface layer, and so on. when the page and the handwriting content written on the page need to be displayed, a plurality of interface layers composing the page to be displayed will be acquired and combined in accordance with the hierarchical relationship and positional relationship between the plurality of interface layers, and the handwriting layer will be superimposed on the whole obtained by combining, so that the screen projection image can be obtained.

Further, when performing layer synthesis processing, a signalLayerUpdate function will be called to apply to a system service to perform layer synthesis processing on the updated handwriting layer and the plurality of interface layers to be displayed, so as to obtain the screen projection image through synthesis, that is: when only the handwriting content changes and the contents of the interface (which can be understood as the contents of the page to be displayed, the same below) do not change, a signalLayerUpdate function will be called to apply to a system service (SurfaceFlinger) to perform layer synthesis processing, and then the system service will perform layer synthesis processing on the updated handwriting layer and the plurality of interface layers composing the page to be displayed, so as to obtain the screen projection image through synthesis.

It should be noted here that, in actual implementation, the above-mentioned steps S220 and S230 can be executed synchronously in two separate threads, and specifically, by utilizing a first thread, the interface image stored in the display cache is modified based on the handwriting report point data; and by utilizing a second thread, handwriting content drawn on a handwriting layer is updated in a system cache based on the handwriting report point data, and a screen projection image is obtained by performing layer synthesis processing on the updated handwriting layer and a plurality of interface layers to be displayed after completing each updating. In this way, the processes of refresh and display in the ink screen and the screen projection display can be independent of each other, which further ensures smooth handwriting and real-time screen projection.

a step S240: cancelling writing the screen projection image into the display cache.

Specifically, when only the handwriting content changes, the contents displayed by the modified interface image and the obtained screen projection image through synthesis are the same. Based on this, in the present embodiment, by cancelling writing the screen projection image into the display cache, repeated refresh and display by the ink screen due to repeated writing the same display contents into the display cache will be avoided, thereby preventing display of the ink screen from being stuck.

Further, in actual implementation, a caching mark can be set for the behavior of performing layer synthesis processing on the updated handwriting layer and a plurality of interface layers to be displayed to obtain the screen projection image, and when writing the screen projection image into the display cache, it will be determined whether to cancel writing the screen projection image into the display cache by querying the caching mark. Optionally, a caching mark may be set as a first mark, and the cancelling writing the screen projection image into the display cache specifically is, when the screen projection image is to be written into the display cache, whether the caching mark is the first mark is detected, and if so, it indicates that only the handwriting content changes, and at this time the display contents of the screen projection image and the interface image updated in the display cache are the same and writing the screen projection image into the display cache is cancelled. By this method of writing the screen projection image into the display cache based on the caching mark, writing the screen projection image into the display cache can be cancelled when only the handwriting content changes, and at the same time, the screen projection image can be written into the display cache in the event that the interface image changes, so as to ensure the contents displayed in the ink screen and the screen projection device are the same.

So far, the above-mentioned steps S210 to S240 are mainly aimed at realization of the refresh and display in the ink screen and the real-time screen projection in the screen projection device when only the handwriting content changes. But in practice, the interface contents will also be updated. In view of this situation, the real-time screen projection display and the refresh and display in the ink screen will be realized through the following step S250.

a step S250: obtaining the screen projection image by performing layer synthesis processing based on a request for updating interface contents, sending the screen projection image to the screen projection device for the screen projection device to display the screen projection image, and writing the screen projection image as the modified interface image into the display cache, so that the display cache synchronizes the modified interface image to the ink screen for display.

The interface contents refer to the contents of the page to be displayed, and the interface contents do not include the handwriting content.

Specifically, with the update of the handwriting layer, the newest handwriting layer will be recorded, so that the newest handwriting content can be reflected in the newest note layer, and the newest handwriting layer can be used to perform layer synthesis processing when the interface contents are updated. Wherein it is determined whether to trigger a request for updating interface contents of the ink screen, the request for updating interface contents including: a request for displaying a new page, such as a request for jumping from the currently displayed page A to page B; or a request for displaying or hiding part of contents of the current page, for example, a request for changing the hand menu bar in page A from a hidden state to a call-out state; or the request for updating interface contents of the ink screen, which can be triggered by a user, for example, triggering a page jump by the user; or request for updating interface contents of the ink screen, which is triggered by a reader automatically, for example, automatically triggering the jump when the page display time duration reaches a predetermined time duration. When the request for updating interface contents is triggered, a plurality of updated interface layers will be determined. When an request for updating page contents is triggered, it indicates that while the handwriting content are displayed in the ink screen and the screen projection device synchronously, it needs to further display the updated interface contents synchronously in the ink screen and in the screen projection device, and at this time, on the basis of the last performing of the layer synthesis processing on the updated handwriting layer and the plurality of interface layers to be displayed to obtain the screen projection image, layer synthesis processing is performed on the newest handwriting layer and a plurality of updated interface layers to obtain the screen projection image, The plurality of updated interface layers refer to a plurality of interface layers corresponding to the updated interface contents, and the screen projection image obtained through this layer synthesis processing includes the newest handwriting content and the updated interface contents. When the request for updating interface contents is triggered, the system service will automatically execute the above steps of determining a plurality of updated interface layers and performing layer synthesis processing, so as to quickly obtain the screen projection image.

Further, after the screen projection image is obtained this time, on the one hand, the newest handwriting content and the updated interface contents can be displayed on the screen of the screen projection device; at the same time, the screen projection image can be written into the display cache as the modified interface image, and the newest handwriting content and the updated interface contents can be displayed in the ink screen synchronously. It should be noted here that, the same as in step S240, here writing the screen projection image into the display cache may also be determined based on the caching mark, and when only the handwriting content changes, the caching mark will be set as the first mark (the behavior of layer synthesis processing performed by triggering the update of the interface contents does not set the first mark), and the operation of writing the screen projection image into the display cache will be performed, so as to realize the simultaneous display of the updated interface contents and the newest handwriting content in the ink screen and the screen projection device.

In order to facilitate the understanding of the information display scheme of the present embodiment, explanation will be performed below by giving a specific example. The user draws a circle clockwise, and as the handwriting point moves, on the one hand, the interface image in the display cache is continuously modified and displayed in the ink screen; and on the other hand, by gradually extending the curve corresponding to the drawing process in the handwriting layer, and performing layer synthesis processing on the updated handwriting layer and a plurality of interface layers, the screen projection image is obtained and sent to the screen projection device for display. When the user draws to the 6 o'clock position, he lifts the pen to stop the handwriting operations. At this time, the handwriting content displayed in the ink screen is a half circle drawn clockwise, and at the same time what is displayed in the screen projection device is also the handwriting content which draw a half circle. If the user clicks the middle area of the screen with a finger to call up the menu, then the system service will automatically acquire a plurality of updated interface layers which include a layer for displaying the menu and acquire the handwriting layer with the drawn half circle. All of the layers are merged to form a new screen projection image, which is written into the display cache for replacing the previously displayed interface image and is displayed, so that an image including the menu and the newest handwriting content is displayed in the ink screen; and the new screen projection image is sent to the screen projection device, and the update of the interface contents can be synchronously displayed in the screen projection device, that is, the menu is displayed.

In addition, with the above solution of the present disclosure, cooperative work can be performed between at least two readers, wherein at least one of the at least two readers can be used as a screen projection device for any other reader, that is, the handwriting content in one of the readers can be projected into the screen of at least one of the other readers for display. For example, if there are two readers, which are reader 1 and reader 2, respectively, the reader 2 can project and display the handwriting content in the reader 1, And after receiving the screen projection image sent by the reader 1, the screen projection image can be displayed in the reader 2. Moreover, a handwriting operations can also be performed on the displayed screen projection image on the reader 2, and when performing a handwriting operations, on the basis of the handwriting content generated in the reader 1, the newly added handwriting content can be displayed in the reader 2 in accordance with the aforementioned scheme, or can also be transmitted to the reader 1 for display in the aforementioned manner, thereby realizing the function of multi-party synchronous writing.

According to the method of displaying information provided by the present embodiment, when the handwriting report point data generated by the handwriting operations is detected, the modified interface image will be obtained by way of image modification to be refreshed and displayed in the ink screen, and the screen projection image will be obtain by way of layer synthesis processing to be projected in the screen projection device, so as to realize real-time screen projection while the corresponding speed of handwriting is ensured; when only the handwriting content changes, writing the screen projection image into the display cache will be canceled, so as to avoid frequent refresh and display of the ink screen due to frequent modification of the interface image in the display cache, which improves the fluency of the display of the ink screen; and when a request for updating interface contents is detected, the system service automatically performs layer merging processing on the newest handwriting layer and a plurality of updated interface layers to obtain a screen projection image including the newest handwriting content and the updated interface contents, and writes the screen projection image into the display cache, which ensures the synchronous display of the ink screen and the screen projection device in the event that the interface contents are updated.

An embodiment of the present disclosure provides a non-volatile computer storage medium, in which at least one executable instruction is stored, the computer-executable instruction being able to execute a method of displaying information in any of the above method embodiments.

The executable instruction specifically may be configured to cause a processor to perform the following operations of:

detecting handwriting report point data generated based on handwriting operations;

modifying an interface image stored in a display cache based on the handwriting report point data, and synchronizing the modified interface image to an ink screen for display; and

updating handwriting content drawn on a handwriting layer in a system cache based on the handwriting report point data, obtaining a screen projection image by performing layer synthesis processing on the updated handwriting layer and a plurality of interface layers to be displayed after completing each updating, and sending the screen projection image to a screen projection device for displaying the screen projection image.

In an optional embodiment, the executable instruction further causes the processor to perform the following operation of: cancelling writing the screen projection image into the display cache.

In an optional embodiment, the executable instruction further causes the processor to perform the following operations of: setting a caching mark as a first mark; and detecting whether the caching mark is the first mark when writing the screen projection image into the display cache, and if so, cancelling writing the screen projection image into the display cache.

In an optional embodiment, the executable instruction further causes the processor to perform the following operations of:

recording newest handwriting layer; determining whether to trigger a request for updating interface contents of the ink screen, wherein the interface contents do not include handwriting content;

determining a plurality of updated interface layers when the request for updating interface contents of the ink screen is triggered; and

performing the layer synthesis processing on the newest handwriting layer and the plurality of updated interface layers to obtain the screen projection image.

In an optional embodiment, triggering the request for updating interface contents of the ink screen further includes at least one of: triggering the request for updating interface contents of the ink screen by a user; and triggering the request for updating interface contents of the ink screen by a reader automatically.

In an optional embodiment, the executable instruction further causes the processor to perform the following operations of:

acquiring the interface image stored in the display cache; and

adding handwriting content onto the interface image based on the handwriting report point data, and writing the interface image with the added handwriting content into the display cache as the modified interface image.

In an optional embodiment, the executable instruction further causes the processor to perform the following operations of: obtaining a driving waveform by looking up a table according to the modified interface image; and driving ink particles to move according to the driving waveform so as to display the modified interface image on the ink screen.

In an optional embodiment, the executable instruction further causes the processor to perform the following operation of: updating the handwriting content drawn on the handwriting layer in the system cache according to the handwriting report point data and preset handwriting parameters; wherein the preset handwriting parameters include at least one of line color, line width and stroke effect.

In an optional embodiment, the handwriting report point data include at least one of handwriting point coordinates, handwriting moving speed, and pressure-sensitive data.

In an optional embodiment, the executable instruction further causes the processor to perform the following operation of: superimposing the updated handwriting layer onto the plurality of interface layers to obtain the screen projection image.

In an optional embodiment, the executable instruction further causes the processor to perform the following operation of: calling a signalLayerUpdate function to apply to a system service for performing the layer synthesis processing on the updated handwriting layer and the plurality of interface layers to be displayed to obtain the screen projection image.

In an optional embodiment, the handwriting layer is a transparent layer; a size of the handwriting layer is the same as a size of an interface of the ink screen.

In an optional embodiment, the executable instruction further causes the processor to perform the following operations of:

by utilizing a first thread, modifying the interface image stored in the display cache based on the handwriting report point data; and

by utilizing a second thread, updating handwriting content drawn on a handwriting layer in a system cache based on the handwriting report point data and obtaining a screen projection image by performing layer synthesis processing on the updated handwriting layer and a plurality of interface layers to be displayed after completing each updating.

FIG. 4 shows a schematic structural diagram of an embodiment of a reader of the present disclosure, and the specific embodiments of the present disclosure do not limit the specific implementation of the reader.

As shown in FIG. 4, the reader may include: a processor 402, a Communications Interface 404, a memory 406, and a communication bus 408.

Wherein the processor 402, the Communication Interface 404, and the memory 406 communicate with each other through the communication bus 408. The Communication Interface 404 is configured for communicating with network elements of other devices such as clients or other servers. The processor 402 is configured to execute a program 410, and specifically may execute the relevant steps in the above embodiments of the method of displaying information for a reader.

Specifically, the program 410 may include program code, which includes computer operation instructions.

The processor 402 may be a central processing unit (CPU), or an application specific integrated circuit (ASIC), or one or more integrated circuits configured to implement the embodiments of the present disclosure. The one or more processors included in the reader may be the same type of processors, such as one or more CPUs; or may be different types of processors, such as one or more CPUs and one or more ASICs.

The memory 406 is configured to store the program 410. The memory 406 may include high-speed RAM memory, and may also include non-volatile memory, such as at least one disk memory.

The program 410 specifically may be configured to cause the processor 402 to perform the following operations of:

detecting handwriting report point data generated based on handwriting operations;

modifying an interface image stored in a display cache based on the handwriting report point data, and synchronizing the modified interface image to an ink screen for display; and

updating handwriting content drawn on a handwriting layer in a system cache based on the handwriting report point data, obtaining a screen projection image by performing layer synthesis processing on the updated handwriting layer and a plurality of interface layers to be displayed after completing each updating, and sending the screen projection image to a screen projection device for displaying the screen projection image.

In an optional way, the program 410 further causes the processor 402 to perform the following operation of: cancelling writing the screen projection image into the display cache.

In an optional way, the program 410 further causes the processor 402 to perform the following operations of: setting a caching mark as a first mark; and detecting whether the caching mark is the first mark when writing the screen projection image into the display cache, and if so, cancelling writing the screen projection image into the display cache.

In an optional way, the program 410 further causes the processor 402 to perform the following operations of:

recording newest handwriting layer; determining whether to trigger a request for updating interface contents of the ink screen, wherein the interface contents do not include handwriting content;

determining a plurality of updated interface layers when the request for updating interface contents of the ink screen is triggered; and

performing the layer synthesis processing on the newest handwriting layer and the plurality of updated interface layers to obtain the screen projection image.

In an optional way, triggering the request for updating interface contents of the ink screen further includes at least one of: triggering the request for updating interface contents of the ink screen by a user; and triggering the request for updating interface contents of the ink screen by a reader automatically.

In an optional way, the program 410 further causes the processor 402 to perform the following operations of:

acquiring the interface image stored in the display cache; and

adding handwriting content onto the interface image based on the handwriting report point data, and writing the interface image with the added handwriting content into the display cache as the modified interface image.

In an optional way, the program 410 further causes the processor 402 to perform the following operations of: obtaining a driving waveform by looking up a table according to the modified interface image; and driving ink particles to move according to the driving waveform so as to display the modified interface image on the ink screen.

In an optional way, the program 410 further causes the processor 402 to perform the following operation of: updating the handwriting content drawn on the handwriting layer in the system cache according to the handwriting report point data and preset handwriting parameters; wherein the preset handwriting parameters include at least one of line color, line width and stroke effect.

In an optional way, the handwriting report point data comprise at least one of handwriting point coordinates, handwriting moving speed, and pressure-sensitive data.

In an optional way, the program 410 further causes the processor 402 to perform the following operation of: superimposing the updated handwriting layer onto the plurality of interface layers to obtain the screen projection image.

In an optional way, the program 410 further causes the processor 402 to perform the following operation of: calling a signalLayerUpdate function to apply to a system service for performing the layer synthesis processing on the updated handwriting layer and the plurality of interface layers to be displayed to obtain the screen projection image.

In an optional way, the handwriting layer is a transparent layer; a size of the handwriting layer is the same as a size of an interface of the ink screen.

In an optional way, the program 410 further causes the processor 402 to perform the following operations of:

by utilizing a first thread, modifying the interface image stored in the display cache based on the handwriting report point data; and

by utilizing a second thread, updating handwriting content drawn on a handwriting layer in a system cache based on the handwriting report point data and obtaining a screen projection image by performing layer synthesis processing on the updated handwriting layer and a plurality of interface layers to be displayed after completing each updating.

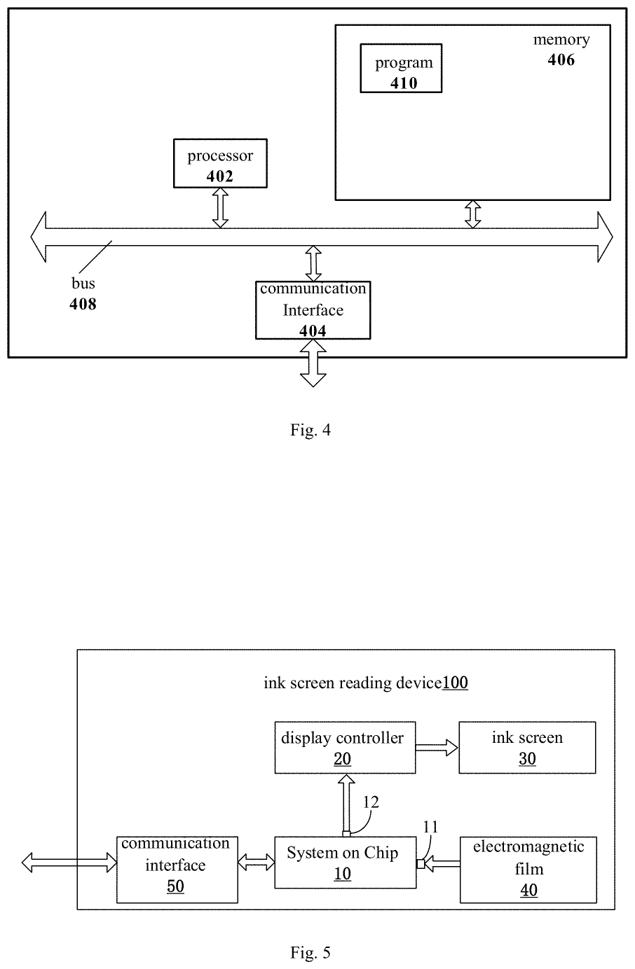

Another embodiment of the present disclosure provides an ink screen reading device that uses the above method of displaying information. FIG. 5 shows a schematic structural diagram of an ink screen reading device provided by an embodiment of the present disclosure. As shown in FIG. 5, the ink screen reading device 100 includes a System on Chip 10, a display controller 20, an ink screen 30, an electromagnetic film 40, and a communication interface 50. The System on Chip 10 is provided with a data input port 11 and a data output port 12. Wherein the System on Chip 10 is an integrated circuit with a dedicated target, which is the main chip of the ink screen reader 100; the display controller 20 is an Electronic Paper Display Controller (EPDC for short) or Timer Control Register (TCON for short), TCON is also referred as a logic board, a screen driver board or a central control board; and the communication interface 50 is an interface for screen projection communication of the System on Chip 10 with an external screen projection device. It is an interface for screen communication, and the screen projection image is sent to the screen projection device through the communication interface 50.

Specifically, the System on Chip 10 is electrically connected with the electromagnetic film 40 through the data input port 11 to receive induction data transmitted by the electromagnetic film 40. After the user touches the electromagnetic film 40 with a handwriting stylus, the electromagnetic film 40 will detect the induction data of handwriting. The induction data is transmitted to the System on Chip 10 through the data input port 11.

On the one hand, the System on Chip 10 is electrically connected with the display controller 20 through the data output port 12 to send the refreshed image to the display controller 20, and the display controller 20 is electrically connected with the ink screen 30 to transmit the driving signals of the refreshed image to ink screen 30, so as to drive the ink screen 30 to display the refreshed image. The System on Chip 10 outputs the refreshed image processed and obtained according to the received induction data to the display controller 20, the refreshed image being a grayscale image, and the display controller 20 is configured to obtain a driving waveform according to a grayscale image Look-Up-Table (LUT for short) and to drive the ink particles on the ink screen 30 to move according to the driving waveform so as to realize imaging.

On the other hand, the System on Chip 10 is electrically connected with the communication interface 50 to transmit the screen projection image to the screen projection device through the communication interface 50. The System on Chip 10 transmits the screen projection image processed and obtained according to the received induction data to the screen projection device through the communication interface 50, and the screen projection device can obtain the screen projection image for screen projection display.

According to the ink screen reading device 100 provided by the present embodiment, the System on Chip 10 therein is electrically connected with the electromagnetic film 40 through the data input port 11. On this basis, firstly, the System on Chip 10 is electrically connected with the display controller 20 through the data output port 12, and the display controller 20 is electrically connected with the ink screen 30, and display of the handwriting content on the ink screen 30 can be realized through the sequential electrical connection among the System on Chip 10, the display controller 20 and the ink screen 30; secondly, the System on Chip 10 is electrically connected with the communication interface 50, and transmission of the screen projection image to the screen projection device for display can be realized at the same time. As can be seen that, in the ink screen reading device provided by the present embodiment, by establishing electrical connection of the System on Chip with the screen projection device and the display controller, respectively, synchronized display of the handwriting content on the ink screen and the screen projection device can be realized in the process of inputting handwriting by a user.

In some optional embodiments of the present disclosure, the System on Chip is configured to prevent the screen projection image from being transmitted to the display controller through the data output port, so that the screen projection image is only transmitted to the screen projection device through the communication interface, and not to the display controller, avoiding stuck display due to frequent refreshing of display of the ink screen. It should be noted here that, in a specific implementation, the specific structure for realizing the resistance control is not limited. For example, two mutually isolated modules in the System on Chip can be used to refresh the image and generate the screen projection image, respectively.

Wherein in some specific embodiments of the present disclosure, the System on Chip includes a cache for storing the refreshed image, and the refreshed image is stored using the cache and transmitted to the display controller, so that the refreshed image is isolated from the screen projection image, then the influence of the screen projection image on the display in the ink screen can be avoided.

In some optional embodiments of the present disclosure, the System on Chip includes a graphic processor, wherein the electrical connection between the System on Chip and the electromagnetic film through the data input port may specifically be: the graphic processor is electrically connected with the electromagnetic film through the data input port, for graphically processing according to the induction data transmitted by the electromagnetic film to obtain the screen projection image. And the electrical connection between the System on Chip and the communication interface may specifically be: the graphic processor is electrically connected with the communication interface, so as to realize transmission of the processed and obtained screen projection image to the screen projection device for display. Wherein the graphic processor is specifically a GPU or a CPU.

In some optional embodiments of the present disclosure, the electromagnetic film and the ink screen are of an integrated structure or a combined structure, wherein the electromagnetic film can be specifically located above the ink screen. Its integration design with the ink screen can reduce the components of the screen and improve the structural stability of the screen. Its combination design with the ink screen can reduce the functional interference between the electromagnetic film and the ink screen.

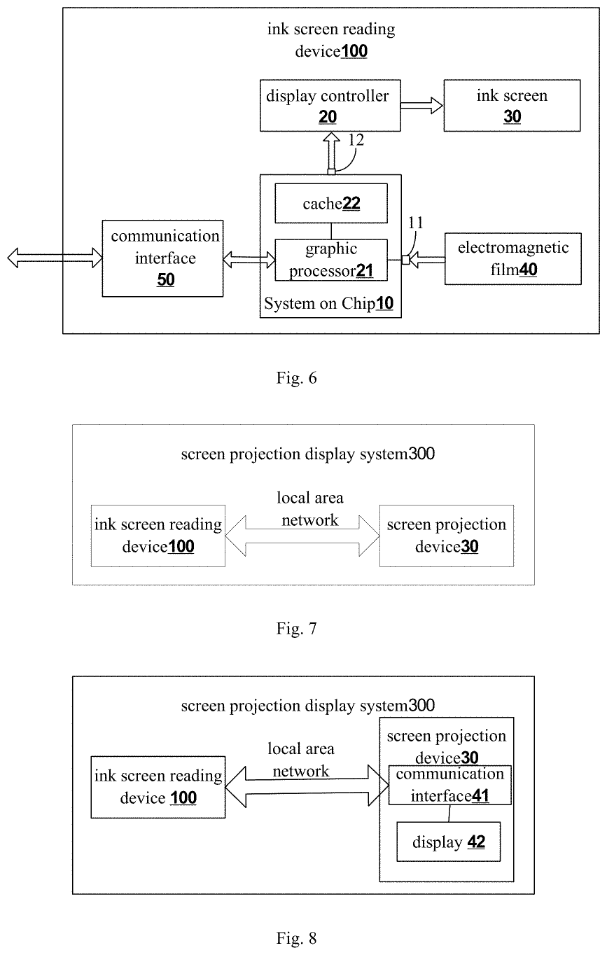

FIG. 6 shows a schematic structural diagram of an ink screen reading device provided by another embodiment of the present disclosure. As shown in FIG. 6, on the basis of FIG. 5, in the ink screen reading device 100, the System on Chip 10 further includes a graphic processor 21 and a cache 22. Wherein the graphic processor 21 is electrically connected with the data input port 11, and the induction data sent from the electromagnetic film 40 can be received through the data input port 11. The graphic processor 21 is electrically connected with the communication interface 50, and transmits the screen projection image obtained by processing to the screen projection device for display through the communication interface 50, so as to realize the screen projection display of the handwriting content; and the refreshed image is separately stored in the cache 22. By sending the refreshed image in the cache 22 to the display controller 20, the display of the handwriting content on the ink screen 30 can be realized, so that the refreshed display of the ink screen 30 is not affected by the screen projection image, and the stability of display of the ink screen 30 is improved. At the same time, the graphic processor 21 is electrically connected with the cache 22, so that the graphics controller 21 can control the refresh of images in the cache 22 and control the sending of the refreshed images in the cache 22 to the display controller 20, thereby facilitating refreshing and display of the ink screen 30.

FIG. 7 shows a composition block diagram of a screen projection display system provided by an embodiment of the present disclosure. As shown in FIG. 7, the screen projection display system 300 includes an ink screen reading device 100 and a screen projection device 30, wherein the ink screen reading device 100 is any ink screen reading device in the foregoing embodiments of the ink screen reading device. In this FIG. 7, only one screen projection device 30 is shown. In practice, the screen projection display system includes an ink screen reading device 100 and at least one screen projection device 30; wherein each screen projection device 30 is connected with the ink screen reading device 100 through a local area network to receive and display the screen projection image sent by the ink screen reading device 100. The screen projection display system provided by the present embodiment can display the screen projection image sent from the ink screen reading device 100 in the screen projection device, thereby realizing the display of the handwriting content in the screen projection device.

FIG. 8 shows a composition block diagram of a screen projection display system provided by another embodiment of the present disclosure. As shown in FIG. 8, the screen projection device 30 further includes a communication interface 41 and a display 42, wherein the display 42 is electrically connected with the communication interface 41, and the display 42 receives the screen projection image sent by the ink screen reading device 100 through the communication interface 41, for displaying the screen projection image. What is specifically received is the screen projection image sent through the communication interface in the ink screen reading device 100. Wherein the screen projection device 30 may be at least one of a projector, a TV, a tablet, a notebook, and a mobile phone.

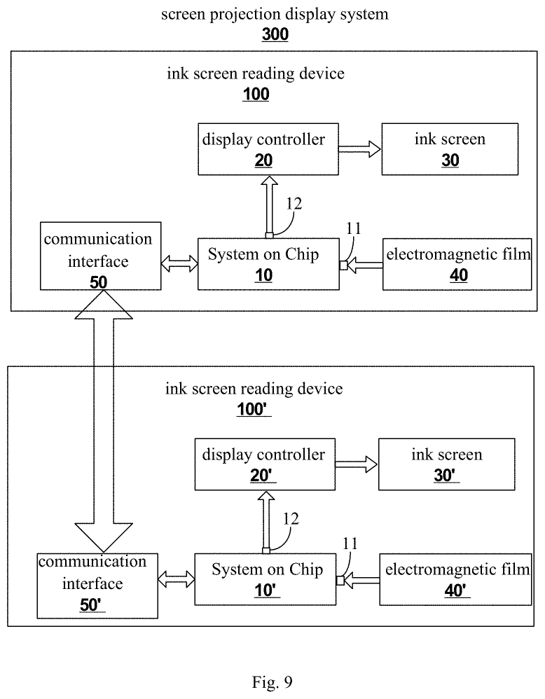

In an optional embodiment of the screen projection display system, the screen projection display system includes at least two of the aforementioned ink screen reading devices, and at least one ink screen reading device of the at least two ink screen reading devices is used as a screen projection device for any other ink screen reading device, that is, the handwriting contents in one of the ink screen reading devices can be screen-projected to at least one other ink screen reading device for display. FIG. 9 shows a composition block diagram of a screen projection display system composed of two ink screen readers.

As shown in FIG. 9, the ink screen reading device 100′, which is a screen projection device, receives the screen projection image through the communication interface 50′, and relies on the electrical connection among the communication interface 50′, the System on Chip 10′ and the display controller 20′ transmit the screen projection image to the screen projection image 20′ and display, and the display in the present reader, of the screen projection image processed and obtained in other ink screen reading devices is realized.

In the meantime, in this optional embodiment, cooperative work can be performed between at least two ink screen reading devices, and any ink screen reading device can be used as a screen projection device for any other ink screen reading device. For example, if there are two readers, which are reader 1 and reader 2, respectively, the reader 2 can project and display the handwriting in the reader 1. After receiving a handwriting image sent by the reader 1, the image is sent to the System on Chip through the communication interface of reader 2, and the System on Chip transmits the image to the display controller; moreover, a handwriting operations can also be performed on the displayed handwriting content on the reader 2, and when performing a handwriting operations, on the basis of the handwriting content generated in the reader 1, the newly added handwriting content can be displayed in the reader 2 in accordance with the aforementioned scheme, or can also be transmitted to the reader 1 for display in the aforementioned manner, thereby realizing the function of multi-party synchronous writing.

In the description of the present application, it should be understood that the orientation or positional relationship indicated by the terms “upper”, “lower”, etc. is based on the orientation or positional relationship shown in the accompanying drawings, and is only for the convenience of describing the present disclosure and simplifying the description, It is not intended to indicate or imply that the referred device or element must have a particular orientation, be constructed and operate in a particular orientation and therefore should not be construed as a limitation of the present disclosure.

The algorithms or displays provided herein are not inherently related to any particular computer, virtual system, or other device. Various general-purpose systems can also be used with teaching based on this. The structure required to construct such a system is apparent from the above description. Furthermore, embodiments of the present disclosure are not directed to any particular programming language. It should be understood that various programming languages may be used to implement the disclosures described herein, and that the descriptions of specific languages above are intended to disclose preferred embodiments of the disclosure.

In the description provided herein, numerous specific details are set forth. It will be understood, however, that embodiments of the present disclosure may be practiced without these specific details. In some instances, well-known methods, structures and techniques have not been shown in detail in order not to obscure an understanding of this description.

Similarly, it is to be understood that in the above description of exemplary embodiments of the present disclosure, various features of embodiments of the present disclosure are sometimes grouped together into a single implementation in order to simplify the present disclosure and to aid in the understanding of one or more of the various disclosed aspects, examples, figures, or descriptions thereof. However, this method of disclosure should not be interpreted as reflecting an intention that the claimed disclosure requires more features than are expressly recited in each claim. Rather, as the following claims reflect, disclosed aspects lie in less than all features of a single foregoing disclosed embodiment. Thus, the claims following the Detailed Description are hereby expressly incorporated into this Detailed Description, with each claim standing on its own as a separate embodiment of the present disclosure.

Those skilled in the art will understand that the modules in the device in the embodiment can be adaptively changed and arranged in one or more devices different from the embodiment. The modules or units or components in the embodiments may be combined into one module or unit or component, and further they may be divided into multiple sub-modules or sub-units or sub-assemblies. All features disclosed in this specification (including accompanying claims, abstract and drawings) and any method or apparatus so disclosed may be employed in any combination, unless at least some of such features or procedures or elements are mutually exclusive. All processes or units are combined. Each feature disclosed in this specification (including the accompanying claims, abstract and drawings) may be replaced by alternative features serving the same, equivalent or similar purpose, unless expressly stated otherwise.

Furthermore, it is to be understood by those skilled in the art that although some of the embodiments herein include certain features, but not others, included in other embodiments, that combinations of features of the different embodiments are intended to be within the scope of the present disclosure And form different embodiments. For example, in the following claims, any of the claimed embodiments may be used in any combination.

Various component embodiments of the present disclosure may be implemented in hardware, or in software modules running on one or more processors, or in a combination thereof. Those skilled in the art will appreciate that a microprocessor or digital signal processor (DSP) may be used in practice to implement some or all of the functions of some or all of the components according to the embodiments of the present disclosure. The present disclosure can also be implemented as apparatus or apparatus programs (e.g., computer programs and computer program products) for performing some or all of the methods described herein. Such a program implementing the present disclosure may be stored on a computer-readable medium, or may be in the form of one or more signals. Such signals may be downloaded from Internet sites, or provided on carrier signals, or in any other form.

It should be noted that the above-described embodiments illustrate rather than limit the disclosure, and that alternative embodiments may be devised by those skilled in the art without departing from the scope of the appended claims. In the claims, any reference signs placed between parentheses shall not be construed as limiting the claim. The word “comprising” does not exclude the presence of elements or steps not listed in a claim. The word “a” or “an” preceding an element does not exclude the presence of a plurality of such elements. The present disclosure may be implemented by means of hardware comprising several different elements and by means of a suitably programmed computer. In a unit claim enumerating several means, several of these means may be embodied by one and the same item of hardware. The use of the words first, second, and third, etc. do not denote any order. These words can be interpreted as names. The steps in the above embodiments should not be construed as limitations on the execution order unless otherwise specified.

1. A method of displaying information, comprising:
detecting handwriting report point data generated based on handwriting operations;
modifying an interface image stored in a display cache based on the handwriting report point data to quickly obtain a modified interface image, and synchronizing the modified interface image to an ink screen for improving a speed of displaying handwriting content on the ink screen;
updating a handwriting layer in a system cache based on the handwriting report point data;
obtaining a screen projection image by performing layer synthesis processing on the updated handwriting layer and a plurality of interface layers to be displayed in response to determining that the updating is completed; and
sending the screen projection image to a screen projection device for displaying the screen projection image in real-time on the screen projection device.

2. The method according to claim 1, further comprising:
cancelling writing the screen projection image into the display cache after obtaining the screen projection image.

3. The method according to claim 2,
wherein the method further comprises setting a caching mark as a first mark after obtaining the screen projection image; and
wherein the cancelling writing the screen projection image into the display cache further comprises:
detecting whether the caching mark is the first mark when writing the screen projection image into the display cache, and
in response to detecting that the caching mark is the first mark, cancelling writing the screen projection image into the display cache.

4. The method according to claim 1, further comprising:
recording newest handwriting layer;
determining whether to trigger a request for updating interface contents of the ink screen, wherein the interface contents do not include handwriting content;
wherein the obtaining a screen projection image by performing layer synthesis processing on the updated handwriting layer and a plurality of interface layers to be displayed further comprises:
determining a plurality of updated interface layers when the request for updating interface contents of the ink screen is triggered, and
performing the layer synthesis processing on the newest handwriting layer and the plurality of updated interface layers to obtain the screen projection image.

5. The method according to claim 4, wherein triggering the request for updating interface contents of the ink screen further comprises at least one of: triggering the request for updating interface contents of the ink screen by a user; or triggering the request for updating interface contents of the ink screen by a reader automatically.

6. The method according to claim 1, wherein the modifying an interface image stored in a display cache based on the handwriting report point data further comprises:
acquiring the interface image stored in the display cache;
adding handwriting content onto the interface image based on the handwriting report point data;
writing the interface image with the added handwriting content into the display cache as the modified interface image.

7. The method according to claim 6, wherein the synchronizing the modified interface image to an ink screen further comprises:
obtaining a driving waveform by looking up a table according to the modified interface image; and
driving ink particles to move according to the driving waveform so as to display the modified interface image on the ink screen.

8. The method according to claim 1, wherein the updating a handwriting layer in a system cache based on the handwriting report point data further comprises:
updating handwriting content drawn on the handwriting layer in the system cache according to the handwriting report point data and preset handwriting parameters, wherein the preset handwriting parameters comprise at least one of line color, line width, or stroke effect.

9-10. (canceled)

11. The method according to claim 1, wherein the obtaining a screen projection image by performing layer synthesis processing on the updated handwriting layer and a plurality of interface layers to be displayed further comprises:
calling a signalLayerUpdate function to apply to a system service for performing the layer synthesis processing on the updated handwriting layer and the plurality of interface layers to be displayed to obtain the screen projection image.

12. (canceled)

13. The method according to claim 1,
wherein the modifying an interface image stored in a display cache based on the handwriting report point data further comprises:
by utilizing a first thread, modifying the interface image stored in the display cache based on the handwriting report point data; and
wherein the updating a handwriting layer in a system cache based on the handwriting report point data and the obtaining a screen projection image by performing layer synthesis processing on the updated handwriting layer and a plurality of interface layers to be displayed further comprises:
by utilizing a second thread, updating the handwriting layer in the system cache based on the handwriting report point data and obtaining the screen projection image by performing layer synthesis processing on the updated handwriting layer and the plurality of interface layers to be displayed.

14. A reader, comprising: a processor, a memory, a communication interface and a communication bus, wherein the processor, the memory and the communication interface communicate with each other through the communication bus, wherein the memory is configured to store executable instructions that upon execution cause the processor to perform operations, the operations comprising:
detecting handwriting report point data generated based on handwriting operations;
modifying an interface image stored in a display cache based on the handwriting report point data to quickly obtain a modified interface image, and synchronizing the modified interface image to an ink screen for improving a speed of displaying handwriting content on the ink screen;
updating a handwriting layer in a system cache based on the handwriting report point data;
obtaining a screen projection image by performing layer synthesis processing on the updated handwriting layer and a plurality of interface layers to be displayed in response to determining that the updating is completed; and
sending the screen projection image to a screen projection device for displaying the screen projection image in real-time on the screen projection device.

15. The reader according to claim 14, wherein the operations further comprise:
cancelling writing the screen projection image into the display cache after obtaining the screen projection image.

16. The reader according to claim 15, wherein the operations further comprise:
setting a caching mark as a first mark after obtaining the screen projection image; and
detecting whether the caching mark is the first mark when writing the screen projection image into the display cache; and
in response to detecting that the caching mark is the first mark, cancelling writing the screen projection image into the display cache.

17. The reader according to claim 14, wherein the operations further comprise:
recording newest handwriting layer;
determining whether to trigger a request for updating interface contents of the ink screen, wherein the interface contents do not include handwriting content;
determining a plurality of updated interface layers when the request for updating interface contents of the ink screen is triggered; and
performing the layer synthesis processing on the newest handwriting layer and the plurality of updated interface layers to obtain the screen projection image.

18. The reader according to claim 17, wherein triggering the request for updating interface contents of the ink screen further comprises at least one of: triggering the request for updating interface contents of the ink screen by a user; or triggering the request for updating interface contents of the ink screen by a reader automatically.

19. The reader according to claim 14, wherein the operations further comprise:
acquiring the interface image stored in the display cache;
adding handwriting content onto the interface image based on the handwriting report point data;
writing the interface image with the added handwriting content into the display cache as the modified interface image.

20. (canceled)

21. The reader according to claim 14, wherein the operations further comprise:
updating handwriting content drawn on the handwriting layer in the system cache according to the handwriting report point data and preset handwriting parameters, wherein the preset handwriting parameters comprise at least one of line color, line width, or stroke effect.

22-23. (canceled)

24. The reader according to claim 14, wherein the operations further comprise: calling a signalLayerUpdate function to apply to a system service for performing the layer synthesis processing on the updated handwriting layer and the plurality of interface layers to be displayed to obtain the screen projection image.

25. (canceled)

26. The reader according to claim 14, wherein the operations further comprise:
by utilizing a first thread, modifying the interface image stored in the display cache based on the handwriting report point data; and
by utilizing a second thread, updating the handwriting layer in the system cache based on the handwriting report point data and obtaining the screen projection image by performing layer synthesis processing on the updated handwriting layer and the plurality of interface layers to be displayed.

27. A non-transitory computer readable storage medium storing executable instructions, wherein the executable instructions upon execution by a processor cause the processor to perform operations of:
detecting handwriting report point data generated based on handwriting operations;
modifying an interface image stored in a display cache based on the handwriting report point data to quickly obtain a modified interface image, and synchronizing the modified interface image to an ink screen for improving a speed of displaying handwriting content on the ink screen;
updating a handwriting layer in a system cache based on the handwriting report point data;
obtaining a screen projection image by performing layer synthesis processing on the updated handwriting layer and a plurality of interface layers to be displayed in response to determining that the updating is completed; and
sending the screen projection image to a screen projection device for displaying the screen projection image in real-time on the screen projection device.

28-38. (canceled)
